(19) United States
(12) Patent Application Publication
(10) Pub. No.: US 2026/0194155 A1
(43) Pub. Date: Jul. 9, 2026

(54) THERMAL MANAGEMENT MODULE

(71) Applicant: BONTAZ CENTRE, MARNAZ (FR)

(72) Inventors: Adrien PLEUHS, ANNECY (FR); Damien DUMANGE, MARIGNIER (FR); Hugo FIEGEL, MARIGNIER (FR)

(21) Appl. No.: 19/123,952

(22) PCT Filed: Oct. 26, 2023
(86) PCT No.: PCT/FR2023/051683

§ 371 Date: Apr. 24, 2025

(30) Foreign Application Priority Data
Oct. 26, 2022 (FR) FR2211158

(51) Int. Cl. F16K 31/04; F16K 11/16; F16K 31/53

(52) U.S. Cl. CPC F16K 31/042; F16K 11/165; F16K 31/043; F16K 31/535

(57) ABSTRACT

A rotary drive device for a distributor provided with an output shaft. The drive device includes a drive element, in rotation about an axis of rotation aligned with the output shaft. An actuator with linear movement along an axis different from the axis of rotation. A coupler between the actuator with linear movement and the drive element to actuate the drive element toward the output shaft of the distributor body. A clutch to engage the axis of rotation and the output shaft.

### RELATED APPLICATIONS

This application is a § 371 application from PCT/FR 2023/051683 filed Oct. 26, 2023, which claims priority from French Patent Application No. 2211158 filed Oct. 26, 2022, each of which is herein incorporated by reference in its entirety.

### FIELD OF THE INVENTION

The invention relates to the field of managing one or more fluids, for example water and/or oil, in communicating or independent thermal management systems, for example used to heat or cool subsystems in an electrified or non-electrified motor vehicle, such as electrochemical storage systems, motor(s), converters, etc.

### BACKGROUND OF THE INVENTION

Currently, the flow of fluid such as water in a cooling circuit of a vehicle can be controlled by:
a set of motorized actuators and On/Off valves; or
multi-inlet-multi-outlet valves; or
independent control modules with one or more actuators.

Most of the time, these systems need to be connected to each other by pipes, which can be expensive and heavy. These systems require fluid management by zone, often with complex controls.

The problem therefore arises of finding a simpler system or device for driving a rotating member or for controlling such a device or a system containing it, whether it is, for example, an application to a cooling circuit or to another fluid circuit (or hydraulic circuit).

There is also the problem of finding a device or system for managing or controlling the distribution of one or more fluids in a fluid circuit which is simpler than the known systems, and which can be applied to different types of fluids (glycol water, oil, dielectric fluid, hydrogen, air).

There is also the problem of finding a new device for distributing one or more fluids which can be integrated into a distribution system, and which can be applied to different types of fluids (glycol water, oil, dielectric fluid, hydrogen, air).

There is also the problem of finding a new rotary device for driving a rotary member, for example for a rotary distributor for distributing one or more fluids and/or for a gearwheel of a gear, for example in a system for distributing one or more fluids. Such a rotary drive device preferably includes an engagement and disengagement mechanism, for example to drive this rotary distributor.

Another problem is the bulkiness of a module for managing one or more fluids. Such a system is often bulky: in some embodiments, the height available above the fluid distributor itself may be limited. A less bulky system is therefore sought.

### OBJECT AND SUMMARY OF THE INVENTION

The invention first of all relates to a rotary drive device for a rotary member, said drive device including:
a drive element, for example a gearwheel, rotating about an axis of rotation or extended by a shaft about which it rotates;
an actuator with linear movement along an axis, which may be different from said axis of rotation, to actuate said drive element in the direction of or along the axis of rotation;
means for engaging the axis of rotation (or the drive element), for example of the type including a coupling device using teeth and grooves (or a dog clutch).

The axis of rotation will be aligned with an output shaft of said rotary member when the rotary drive device and the rotary member are combined, the rotary member also comprising means for engaging its output shaft, for example of the type comprising a coupling device using teeth and grooves (or a dog clutch).

The invention also relates to a rotary drive device for a rotary member provided with an output shaft, said drive device including:
a drive element, for example a gearwheel, rotating about an axis of rotation or extended by a shaft about which it rotates aligned with the output shaft of said rotary member;
an actuator with linear movement along an axis, which may be different from said axis of rotation, to actuate said drive element toward the output shaft of the distributor body;
means for engaging the axis of rotation (or the drive element) and the output shaft, for example of the type comprising a coupling device using teeth and grooves (or a dog clutch).

The invention also relates to a rotary drive device, for example for a rotary member provided with an output shaft, said drive device including:
a drive element, for example a gearwheel, rotating about an axis of rotation or extended by a shaft about which it rotates, this shaft being, for example, aligned with an output shaft of said rotary member;
an actuator with linear movement along an axis, which may be different from said axis of rotation, to actuate said drive element linearly along said axis of rotation and/or toward the output shaft of the distributor body;
means for engaging the axis of rotation (or the drive element), and possibly the output shaft, for example of the type including a coupling device using teeth and grooves (or a dog clutch).

The means for engaging the rotary drive device and/or the output shaft may include teeth which may or may not be integrated or integral with the drive element and/or the output shaft. The top of each tooth can be flat or have a taper. The lateral faces of each tooth preferably have a taper, thus making it easier to decouple.

More generally, the means for engaging the axis of rotation and/or the output shaft may include a coupling device using teeth and grooves or a coupling device using keys.

Coupling means may be provided between the actuator with linear movement and the drive element, to actuate the latter or the end of the axis of rotation thereof, for example toward the output shaft of the rotary member. This is, for example, the case if the actuator has linear movement along an axis different from said axis of rotation, for example along an axis parallel to the axis of rotation and separated from it by a distance d not equal to zero.

The coupling means may include a lever pivoting about a pivot, this lever connecting the actuator and the drive element. Such a lever may have arms of equal length, or arms of different lengths, on either side of the pivot.

Such a device according to the invention may also comprise return means for maintaining the means for engaging the axis of rotation and the output shaft in the disengaged position; for example, said actuator and said drive element compress these return means to engage the axis of rotation and the output shaft.

These return means may be arranged at least partially in a compartment, one end of which is provided with part of the engagement means.

Said actuator with linear movement is, for example:
an electromagnetic actuator, including a coil and a plunger which interacts with the field generated by the coil when a current flows through it, for example to compress the return means; or
pneumatic or hydraulic.

A device according to the invention may further include means for guiding the drive element, for guiding it in translation along the axis of rotation.

Said means for guiding this drive element include, for example, a centering support which guides an inner surface of this element; for example, if this element includes a gearwheel, this support guides an inner surface of the wall of the wheel which is provided with teeth.

Alternatively, the output shaft of the rotary member may be extended by a guide shaft to penetrate said drive element.

In a rotary drive device according to the invention:
the drive element may include a gearwheel, the device further including means for driving this wheel, forming with it a vertical shaft gear; and/or
braking means to brake the member or the gearwheel when it is disengaged.

In one exemplary device according to the invention, the rotary member includes a gearwheel.

The invention also relates to a distributor including a rotary distributor body, including at least one inlet and at least one outlet, the sum of the number of inlets and the number of outlets being, for example, greater than or equal to 3, an output shaft, around which the distributor can be rotated, and a rotary drive device according to the invention.

This type of distributor can distribute one or more fluids in a plane, perpendicular to the axis of rotation of a rotary drive device according to the invention, i.e. the fluid(s) thus distributed exit the distributor having a flow direction that is in this plane perpendicular to this axis of rotation. Similarly, the fluid to be distributed enters the distributor with a flow direction that is in this same plane perpendicular to this axis of rotation.

For example, the inlet, respectively the inlets, and the outlets, respectively the outlet, for example an inlet and 2 outlets, direct the fluid(s) in a flow direction that is perpendicular to the axis of rotation of the rotary drive device.

The invention also relates to a system for controlling the flow of at least one fluid in a hydraulic circuit, including:
a motor, for example a brushless motor or a stepper motor;
a plurality of d distributors (D₁-D_{d}) of said fluid, including at least one distributor as described above or in the remainder of the present application, at least one distributor including a rotary drive device according to the invention.

Such a system may further include a plurality of gear trains, each train ensuring the transmission of the movement of the motor to one of said distributors, each gear train including means for directly engaging or disengaging the associated distributor or a gear of this train, these means for engaging or disengaging a gear of this train, or the associated rotary distributor, including at least one device according to the invention.

Such a system is simpler than the known systems since the same motor can operate different distributors.

Each gear train may include:
a first gear stage (E_{1.1}-E_{1.d}), each gear of which is driven by said motor;
a second gear stage (E_{2.1}-E_{2.d}), each gear of which is driven by the first stage.

For example:
in the first gear stage (E_{1.1}-E_{1.d}), each gear of this first stage may be driven by said motor and be associated with a disengageable shaft (A_{1.1}-A_{1.d}) and/or with disengaging means;
a second gear stage (E_{2.1}-E_{2.d}), each gear of which is driven by a gear, or a shaft associated with a gear, of the first gear stage.

A system according to the invention can be used to orient the flow of a fluid, for example water, via distributors controlled independently by the same motor. For example, this fluid from p pumps is distributed using m inlets (the sum of the number of inlets of all distributors) and n outlets (the sum of the number of outlets of all distributors in the system).

According to particular embodiments:
each distributor (Dᵢ) may comprise nₑᵢ inlets and nₛᵢ outlets; and/or
each distributor (Dᵢ) may comprise or be associated with a position sensor (C₁-C_{d}); and/or
the system may include electronic means for controlling the motor;
in even more particular embodiments, these electronic means are able to:
   control the motor as a function of a signal or signals from one or more of said position sensors (C₁-Cd);
   and/or:
   receive an operating mode command;
   determine a target displacement of each of the d distributors;
   control the motor as a function of the target displacement of each distributor.

According to other particular embodiments, each shaft:
is associated with a solenoid to engage or disengage it; and/or
may be held in the rest position by a compression spring (R₁, . . . R_{d}).

A system for distributing one or more fluids according to the invention in a fluid circuit may include:
at least one pump;
a system for controlling the distribution of said fluid according to the invention, as defined above or in the present application.

Such a distribution system may, for example, include one or more systems for exchanging thermal energy.

The invention also relates to a vehicle comprising:
a motor, either thermal or electric, which may, for example, include at least one electrochemical storage system and a converter;
at least one fluid circuit and at least one system for distributing, according to the invention, a fluid in this fluid circuit, as defined above or in the present application.

The invention also relates to a method for controlling the distribution of at least one fluid in a fluid or hydraulic circuit using a system according to the invention, as described above or in the present application, and/or in a vehicle according to the invention, as described above or in the present application.

Such a method preferably includes:
determining and/or selecting one or more distributors to be actuated;
actuating said distributor(s) using the motor and means for engaging said distributor(s).

Such a method may further comprise selecting or determining a direction and/or an angle of rotation of one or more distributors to be actuated and actuating said rotary distributor(s) according to this direction and/or this angle of rotation.

An instruction or control signal may be received in advance, defining an operating mode, or a combination of distributor positions to be reached to distribute the fluid as desired or defined by the instruction or signal.

The position of one or more distributors may be measured, for example by one or more position sensors associated with one or more distributors. According to one embodiment, the fluid(s) may be water, but other fluids may be involved, for example oil, dielectric fluids, or a mixture including glycol or a gas, for example air or hydrogen.

In a device or a method according to the invention, the hydraulic circuit or the fluid circuit may, for example, be a circuit enabling thermal management or a circuit for distributing a fluid in a circuit enabling such thermal management (heating or cooling) or a circuit for distributing oil, dielectric fluid or hydrogen or air in a vehicle or in a device, for example of the domestic type such as a heat pump.

Preferably, in a device or method according to the invention:
when the actuator is activated, the drive element, or the axis of rotation, is engaged with the axis or the output shaft;
when the actuator is deactivated, the drive element, or the axis of rotation, is disengaged with the axis or the output shaft.

### BRIEF DESCRIPTION OF THE DRAWINGS

FIG. 1 shows an exemplary embodiment of a system to which a rotary drive device according to the invention may be applied.

FIG. 2 shows an exemplary embodiment of a gear train in combination with a motor.

FIG. 3A, FIG. 3B and FIG. 3C show an exemplary rotary distributor that may be used in a system according to the invention.

FIG. 4 shows an exemplary embodiment of a drive device according to the invention, or at least certain aspects of which can be used in combination with a drive device according to the invention and/or for or with a rotary distributor according to the invention.

FIG. 5A, FIG. 5B, FIG. 5C and FIG. 5D show another exemplary embodiment of a drive device according to the invention, or at least certain aspects of which can be used in combination with a drive device according to the invention and/or for or with a rotary distributor according to the invention.

FIG. 6 shows an exploded view of a mechanism for engaging and disengaging a drive device according to the invention, or at least certain aspects of which can be used in combination with a drive device according to the invention and/or for or with a rotary distributor according to the invention.

FIG. 7A and FIG. 7B show another exemplary embodiment of a drive device according to the invention, or at least certain aspects of which can be used in combination with a drive device according to the invention for a rotary distributor and/or for or with a rotary distributor according to the invention.

FIG. 8A and FIG. 8B show another exemplary embodiment of a drive device according to the invention for a rotary distributor.

FIG. 9 shows a particular aspect of a mechanism for engaging and disengaging a drive device according to the invention.

FIG. 10 shows an engagement and disengagement system using keys.

FIG. 11A, FIG. 11B and FIG. 11C show another embodiment of a dog clutch that can be used within the scope of the invention.

FIG. 12 shows a fluid supply system including a plurality of mechanisms for engaging and disengaging a drive device according to the invention.

### DETAILED DESCRIPTION OF PARTICULAR EMBODIMENTS

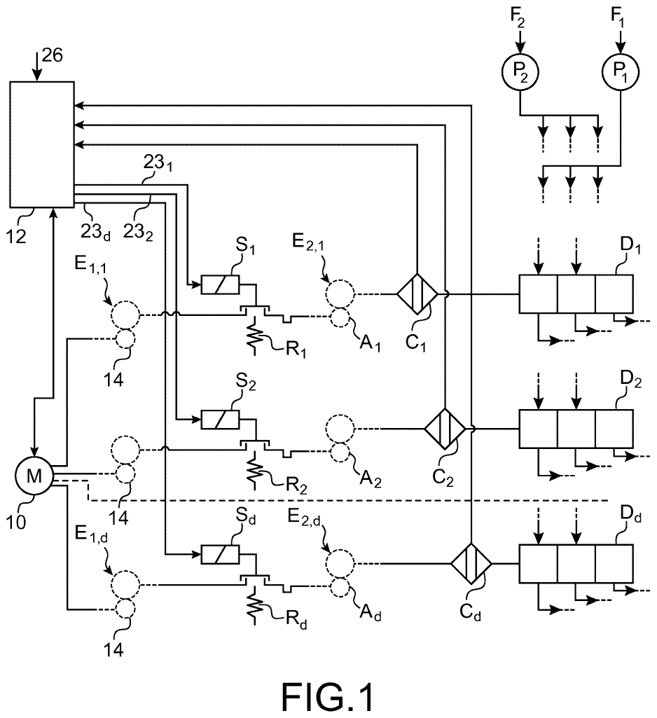

FIG. 1 shows an exemplary embodiment of a hydraulic system or circuit for distributing fluid(s), a rotary drive device according to the invention which can be applied to a rotary distributor and/or to one or more gears of such a system.

In this example, the hydraulic circuit includes 2 pumps P1 and P2, each distributing a fluid F1, F2, but a different number of pump(s) and fluid(s) is part of the scope of the present application. The fluid(s) is/are distributed by rotary distributors Dᵢ, for example of the type according to the invention and/or as described hereinafter.

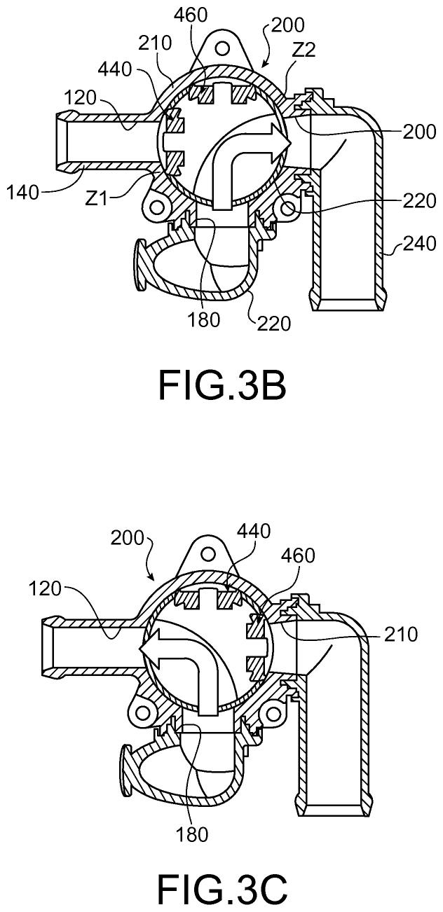

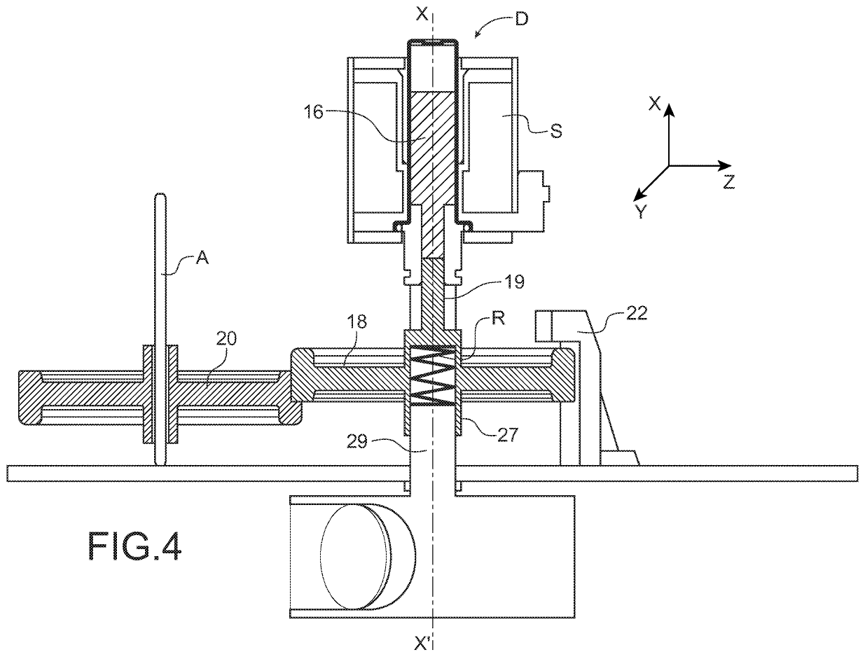

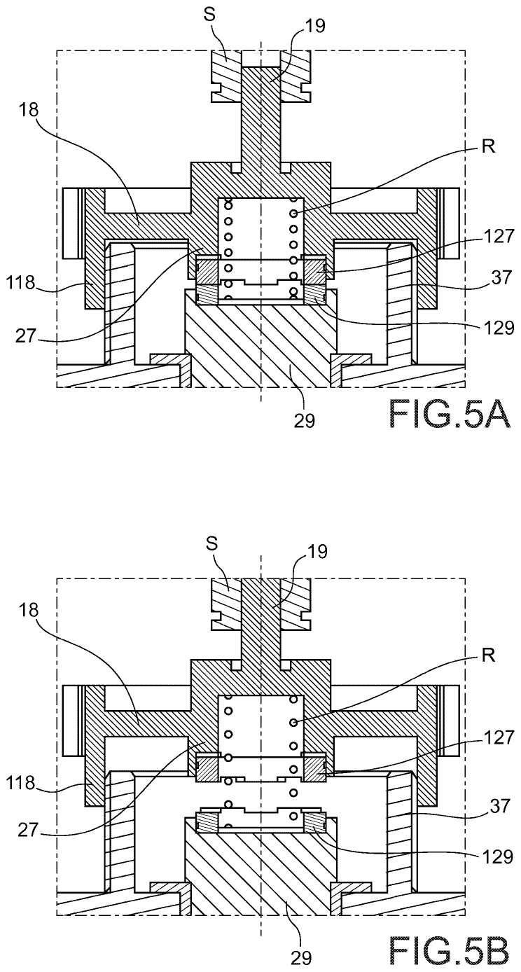

FIGS. 3A-3C are described below and show an exemplary rotary distributor Dᵢ that may be used within the scope of the present invention. FIG. 4 and FIGS. 5A-5C, described below, show exemplary new drive means according to the invention, including an engagement and disengagement mechanism, to drive a rotary distributor, for example such as that shown in FIGS. 3A-3C.

A system for controlling the distribution of the fluids in the hydraulic circuit illustrated in FIG. 1 includes a motor 10, preferably a brushless motor, which drives a central output shaft 14 coupled simultaneously to d gear trains (d≥2).

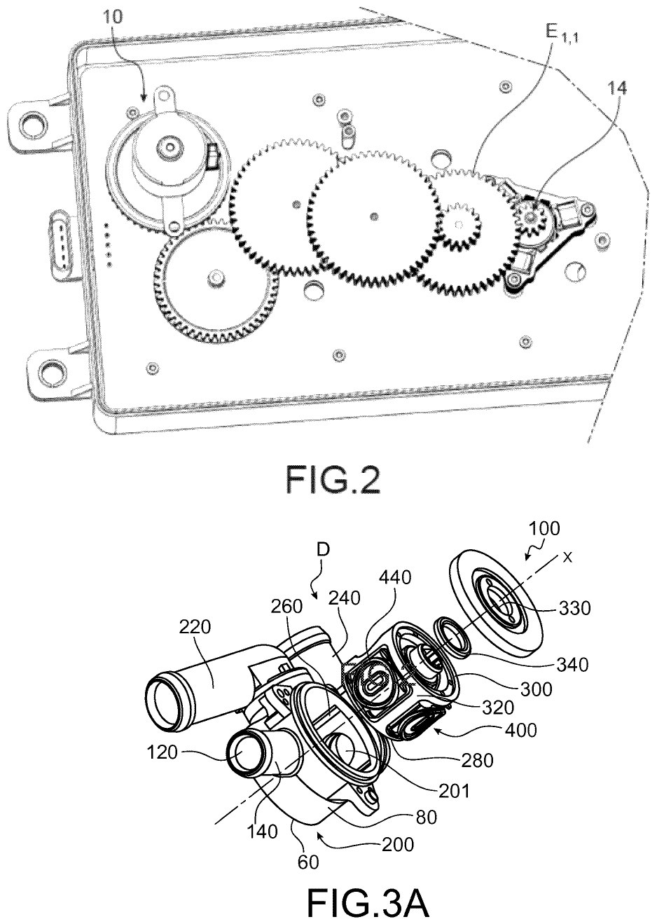

FIG. 1 shows the shaft 14 associated with different gear trains, but these are in fact arranged around the shaft 14 (as in the example in FIG. 2 for a gear train). Electronic control means 12, for example in the form of a printed circuit board (“PCB”), control this motor 10.

The gears of the different trains are preferably spur gears, with parallel shafts. In this example, each gear train includes a first gear (E_{1.1} . . . E_{1.d}) of a first gear stage.

Each of these gears E_{1.1} . . . E_{1.d} rotates, for example, a shaft A₁ . . . A₁ which can be engaged/disengaged independently of the others, using an actuator, for example of the electromagnetic (solenoid) or pneumatic or hydraulic type. FIG. 1 schematically shows electromagnetic actuators (or solenoids) S₁, . . . S_{d}. but other types of actuators are feasible (hydraulic, pneumatic). Each disengageable shaft can be held in the rest position, for example by a compression spring R₁, . . . R_{d}. Each actuator can be controlled by the electronic control means 12.

FIG. 4 is described below and shows an engagement and disengagement mechanism according to the invention for a rotary distributor Dᵢ. This mechanism includes here an electromagnetic actuator, including a solenoid Sᵢ, but, here too, other types of actuators are feasible (hydraulic, pneumatic).

In the exemplary embodiment shown in FIG. 1, the system includes a second gear d stage (E_{2.1} . . . E_{2.d}). Each of these gears of the second stage can be connected to a disengageable shaft and drives a rotary distributor D₁ . . . D_{d}. These d rotary distributors are therefore driven independently of each other.

It should be noted that the actuator can be associated with any of the gearwheels or shafts of each gear train; in FIG. 1, it is the wheel immediately preceding the distributor, but in FIG. 4 it is the wheel associated with the distributor itself. Any gearwheel of each gear train may be associated with the engagement and disengagement means, which makes it possible to disengage or engage the corresponding distributor.

Each of the d distributors can be associated with a position sensor C₁-C_{d} which makes it possible, preferably at any time, to know the position of the distributor to which it is associated. A position signal is sent to the means 12.

Each rotary distributor Dᵢ includes nₑᵢ inlets (nₑᵢ≥1) and nₛᵢ outlets (nₛᵢ≥1), a single-inlet distributor (nₑᵢ=1) comprising a plurality of outlets (nₛᵢ≥2) and a single-outlet distributor (nₛᵢ=1) comprising a plurality of inlets (nₑᵢ >1). The outlets are connected to ducts that lead the fluid to a given application, for example a cooling circuit or a circuit that must be supplied with oil or air (for example an air conditioning circuit) or hydrogen (for example a fuel cell supply circuit). In the example in FIG. 1, the distributor D₁ has one inlet and 2 outlets, the distributor D₂ has 2 inlets and one outlet, the distributor D_{d} has 2 inlets and 3 outlets; any other combination of inlets/outlets may be used.

In FIG. 1, the outlets of the distributors are directed to other members of the hydraulic system; but, alternatively (not shown), one or more outlets of one or more distributors are directed to one or more inlets of another or more other distributors.

On exemplary rotary distributor that can be used within the scope of the present invention is described in the application filed under number FR-202101137; its structure is shown in FIGS. 3A-3C, see the explanations below.

The fluid distribution system also includes a number p (p≥1) of pump(s), connected to the different distributors according to an architecture that is specific to the fluid distribution system in question.

Each of the actuators S₁, . . . S_{d} can be controlled by the means 12 as a function of the position of the different distributors; this position can be known thanks to the signal received by these means 12 from the corresponding position sensor.

In operation, the means 12 receive from the vehicle an operating mode command 26, each operating mode being defined by the engaged or disengaged state of each distributor and by the open and closed positions of all the inlets and outlets of the selected (or engaged) distributors. When all distributors have the same number of x possible positions, the total number of modes equals x^{t}. The data relating to each operating mode can be stored in storage means associated with the means 12 and the position of each distributor can be known by the sensors Cᵢ. Selecting an operating mode therefore defines an engaged or disengaged state of each distributor and a position for each engaged distributor. If required, the storage means may store (or the means 12 may calculate):
in which direction and with which angular displacement each selected distributor can be actuated to move it from a state defined by a certain combination of its inlets/outlets to another state defined by another combination of its inlets/outlets; and/or
the order in which the selected distributors must be engaged; all can be engaged simultaneously or sequentially (and in a certain order) or some of these distributors can be engaged simultaneously, the others being engaged sequentially (again in a certain order).

When one or more distributors must be driven in a direction opposite to the direction in which this or these distributor(s) were previously driven, then the direction of rotation of the motor 10 is reversed. The distributors whose direction of rotation is not reversed are disengaged. When one or more distributor(s) must be driven in a direction opposite to the direction in which one or more other distributor(s) must be driven, the latter are disengaged.

Depending on the selected operating mode, these means 12 can actuate the means for engaging or disengaging the selected distributor(s), and actuate this or these distributor(s) by determining, for example, the direction and angular displacement of each of the distributors in question, as well as the order or sequence of activation (sequential or simultaneous as described above).

The motor 10 is then powered, and depending on the determined sequence and the position of each of the d distributors, the shafts are engaged (or not) sequentially or simultaneously until each of the d distributors has reached the desired position.

This system therefore makes it possible to replace a product consisting of a plurality of valves controlled by as many “brushless” actuators with a set of hydraulic distributors controlled by a single motor 10, for example a brushless or stepper motor, and an engagement and disengagement mechanism associated with each of the distributors.

The means 12, produced for example in the form of a printed circuit, may comprise, for example, a processor or a microprocessor programmed to control the engagement/disengagement means of each distributor and the motor 10 according to a plurality of operating modes as defined above and/or to calculate the actuation of one or more of the distributors as a function of an operating mode selected by an operator or a vehicle.

FIG. 2 shows an exemplary embodiment of a single gear train in combination with a motor 10. This figure shows the motor shaft 14, as well as the first stage E_{1.1}. Other gear trains identical or similar to that shown in FIG. 2 may be arranged around the motor. All of these elements are held or fastened on a support 11. This support may, for example, be made of one or more separate parts mechanically connected by welding and/or by a mechanical system and/or consist of one or more materials.

FIGS. 3A-3C show an exemplary rotary distributor that can be used in a system according to the invention.

It includes one inlet and two outlets, but it is understood that it may comprise one or more inlets and one or more outlets.

This distributor includes a housing 200 or valve body, which is substantially cylindrical in shape in revolution about an axis X, and a central part 400, referred to as the core, mounted in the housing 200 and able to rotate in the housing 200.

In the example shown, the housing 200 includes a bottom 60 and a substantially cylindrical side wall 80 in one piece, and a cover 100 for closing the housing. The cover 100 is, for example, secured to the housing 200 by welding, for example by ultrasonic welding.

The housing 200 includes a port 180, so-called supply port, formed in the side wall 80 and a supply duct 220, for example welded onto the base of the port 180 and intended for a connection to a fluid source, for example a pump such as one of the pumps P1, P2 shown in FIG. 1. On either side of this inlet port 180, the housing 200 also includes:
a first outlet port 210 formed in the side wall 80, extending by a duct 240 intended to bring the liquid to a given area, for example an area to be cooled;
and a second outlet port 120 extended by a duct 140, intended to bring the liquid to another given area.

These outlet ports are intended to distribute a fluid when either of them is positioned opposite the inlet of a distribution duct. Either of these outlet ports is brought in front of this inlet of a distribution duct by rotating the distributor about the axis XX′ and the fluid then exits the distributor with a direction in a plane perpendicular to the axis XX′. There may be a plurality of distribution ducts and a plurality of corresponding inlets of these ducts, all arranged in this plane perpendicular to the axis XX′. In other words, this type of distributor distributes one or more fluids in this plane, i.e. the fluid(s) thus distributed exit the distributor having a flow direction that is in this plane perpendicular to this axis XX′. Similarly, the fluid to be distributed enters the distributor with a flow direction that is in this same plane perpendicular to this axis XX′.

The ducts 140 and 240 are, for example, welded to the base of the ports 210 and 120 respectively. The housing 200 defines a hydraulic chamber 260. The outlet ports 120 and 210 are distributed angularly on the side wall about the axis X on either side of the supply port 180.

The core 400 is intended to be mounted in the hydraulic chamber and is capable of rotating about the axis X. It includes two end faces 280, 300 and a side surface 320. It itself includes at least one duct which makes it possible to connect an inlet 201 and an outlet 203 (as is understood in FIGS. 3B and 3C, the inlet 201, depending on the position of the core around the axis XX, can become the outlet, and vice versa for the outlet 203).

The end face 280 is facing the bottom of the housing and the end face 300 is facing the cover. The end face 300 includes a recess 310 intended to receive the end of a shaft of an actuator, a shaft preferably aligned along the axis X. The cover 100 includes an opening 330 facing the recess 310 to enable coupling with the shaft. Alternatively, the end face 300 includes a protruding coupling member intended to penetrate a recess formed in the shaft of the actuator. Advantageously, a seal 340 is provided between the end face 300 and the cover bordering the recess 310 to prevent fluid leaks.

The core 400 may also include a first seal 440 intended to seal the outlet port 120, when they are opposite each other, and optionally a second seal 460, and intended to seal the outlet port 210, when they are opposite each other. The first seal 440 and the second seal 460 have an identical or similar shape, as well as being mounted on the core.

As already explained above, this distributor can be used to distribute fluid laterally, according to the orientation, around the vertical axis XX′, the core of the distributor: the fluid, or each of the fluids, which is/are thus distributed, at the outlet of the distributor, has a flow direction in the plane perpendicular to the axis XX′.

Thus, in FIG. 3B, in a 1st position, the distributor directs the fluid to the outlet 210; in FIG. 3C, in a 2nd position, after having performed a rotation about the axis XX′, the distributor directs the fluid to the outlet 120.

FIG. 4 shows a mechanism for driving a rotary distributor D, for example of the type described above in connection with FIGS. 3A, 3B and 3C, provided with a shaft or an output shaft 29, and its actuator, herein of the electromagnetic type; the latter includes a solenoid S which, when actuated, actuates a plunger 16, along the axis XX′ in the direction of the shaft 29, a movement that will compress the spring R; the plunger has the magnetic properties to interact with the field generated when a current passes through the solenoid and thus be brought toward the rotary distributor D. The plunger thus pushes a shaft 19 integral with a gearwheel 18, which then meshes with another wheel 20, mounted on a shaft A, itself driven by the motor 10, or by drive means (this wheel itself forms part of a gear train) driven by the motor 10. The wheel 18 is extended in its central part by a compartment or a cylindrical wall 27, which includes means (keys for example) which allow it to be coupled to the output shaft 29 of the distributor, while allowing a translation of the assembly including the wall 27, the wheel 18 and the shaft 19, with respect to the shaft 29. When the plunger has pushed the shaft 19 toward the distributor D, the latter is engaged. When the solenoid action is released, the spring R pushes back the assembly 18-19-27 which then switches to disengagement. The device may further include a brake 22 which is used to brake the distributor (the gearwheel 18) when it is disengaged. The solenoid may be controlled by means such as the means 12 described above. Preferably, the assembly of actuating and drive means is arranged on a wall 150, for example of an actuator housing, of a distributor D which can be arranged below the housing, the shaft 29 of this distributor passing through the wall of this housing. Such a rotary distributor D can be used in a system as described above in connection with FIGS. 1 and 2, which can then be arranged on the wall 150.

Here, as can be seen in this figure, the output shaft 29 of the distributor is aligned with the actuator or the actuator means S, 16. There is therefore a vertical alignment of the distributor and the actuator or the actuator means.

When the return spring pushes the means 18, 19 in the vertical direction (it pushes them and therefore moves them away from the distributor), these means are decoupled from the distributor, but the body of the distributor itself remains in the same position.

In other words, the actuating means S, 16 are located in the axis XX′ of the distributor and can be coupled to, or decoupled from, the latter without modifying the position of the latter along the vertical axis XX′.

The actuator shown here is of the electromagnetic type. However, another type of actuator, for example a pneumatic or hydraulic actuator, may be chosen, which, as in FIG. 4, will also be aligned with the output shaft 29 of the distributor and will also have an actuation direction along the axis XX′; in particular, it will compress the return means (R) to engage the drive means with the distributor, said return means (R) on the other hand pushing back the drive means to disengage them with respect to the distributor, the latter always keeping the same position along the vertical axis XX′.

The gearwheel, or ring gear, 18 is not always integral with the distributor: in the disengaged position, it is decoupled or detached from the latter; again, the distributor always keeps the same position along the vertical axis XX′.

FIGS. 5A-5D show a variant of the drive means, including an engagement and disengagement mechanism, of a rotary distributor D, for example of the type described above in connection with FIGS. 3A-3C; in these FIGS. 5A-5D, reference numerals identical to those in the preceding figures, and in particular in FIG. 4, denote the same elements.

The gearwheel 18 is extended in its lateral portion by a wall or skirt 118, preferably located at the periphery of the wheel, which cooperates with a centering support 37 attached to the support 11. For example, the centering support 37 guides the inner surface of the wall 118 which, on its outer surface, carries the teeth of the wheel.

The engagement means comprise a dog clutch system 127, 129 (or tooth and groove coupling device), a part 127 of which is, for example, arranged at the end of the compartment or of the cylindrical wall 27 and the other part 129 of which is preferably arranged at the end of the output shaft 29 of the distributor. A more detailed representation of the part 129 is shown in FIG. 5D, with its teeth 131-134 and its grooves 135-138 which make it possible to accommodate the teeth of the part 127 when these 2 parts are engaged, the teeth 131-134 being themselves housed in corresponding grooves of the part 127. The other part 127 therefore includes corresponding teeth and grooves. When these 2 parts are engaged, the output shaft 29 of the distributor can be driven by the wheel 18. The number of teeth shown in FIG. 5D is 4, but a different number may be provided.

In this variant of FIGS. 5A-5D, the translational guidance, along the shaft 19, is ensured laterally by the means 37 and 118, at a distance from the shaft 19, while the coupling of the wheel 18 with the body 400 of the distributor is ensured centrally. The actuator S can therefore actuate the plunger 16, which thus pushes the shaft 19 in translation, which shaft is integral on the one hand with the gearwheel 18, and on the other hand with the means 127. It is thus possible to:
on the one hand, mesh the wheel 18 with, for example, another wheel 20, mounted on a shaft A (as in FIG. 4), itself driven, for example, by the motor 10, or by drive means (this wheel itself forms part of a gear train) driven by the motor 10;
on the other hand, engage the shaft 19 with the shaft 29 of the distributor.

Therefore, when the plunger has pushed the shaft 19 toward the distributor D, the latter is engaged (FIG. 5A) and can be actuated to guide a fluid from an inlet to an outlet of the distributor. When the action of the solenoid S is released, the compression spring R pushes back the assembly 18-19-27-127 and the distributor D switches to disengagement (FIG. 5B, both parts 127, 129 of the engagement means being disengaged). FIG. 5C shows another view of the disengaged position.

As in FIG. 4:
the device may further include a brake which is used to brake the distributor (and/or the gearwheel 18) when it is disengaged; and/or
the solenoid S may be controlled by means such as the means 12 described above; and/or
the rotary distributor may be used in a system as described above in connection with FIGS. 1-3C.
Compared to FIG. 4, the device shown with FIGS. 5A-5D reduces wear in particular on the gear teeth; the latter may be made of plastic, for example PPA or PPS, the engagement system described above in connection with FIGS. 5A-5D may be metallic, for example steel.

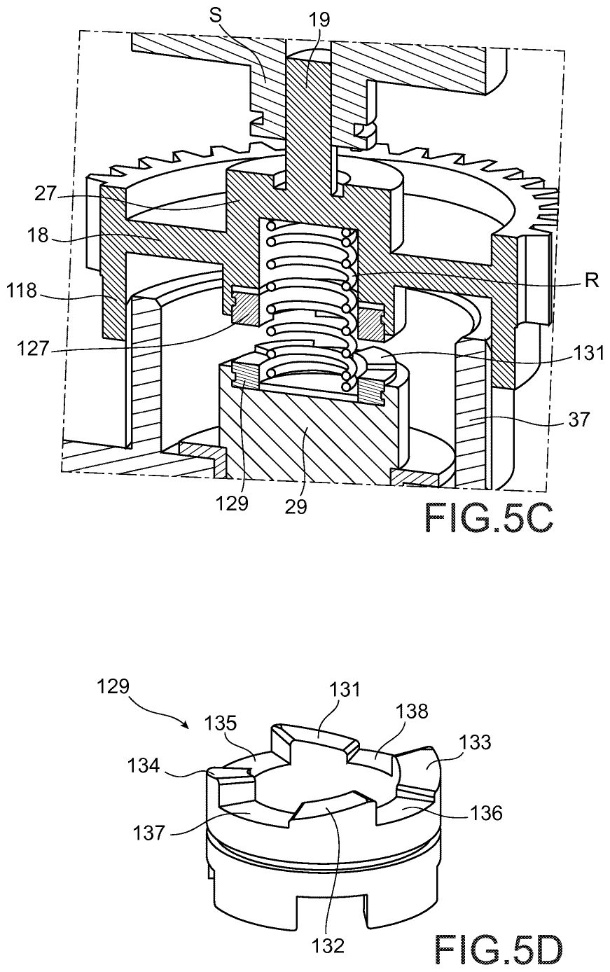

FIG. 6 shows an exploded view of the shaft 19, the wheel 18 and the engagement/disengagement elements with the shaft 29; references 130 and 139 respectively denote an upper spring flange and a lower spring flange. The upper dogs 127 and lower dogs 129 (for example made of steel, for example hardened steel) are intended to be attached respectively to the shaft 19 of the actuator and to the axis of rotation 29.

FIGS. 4 and 5A-5D show drive mechanisms of a rotary distributor D. But one of these mechanisms can be applied to drive another rotary member, provided with a shaft 29, for example another gearwheel, for example in a gear stage such as one of those described above in connection with FIG. 1 or 2.

One of these drive mechanisms can therefore be used to drive a gear stage, itself driving, for example, another gear stage or one or more distributors.

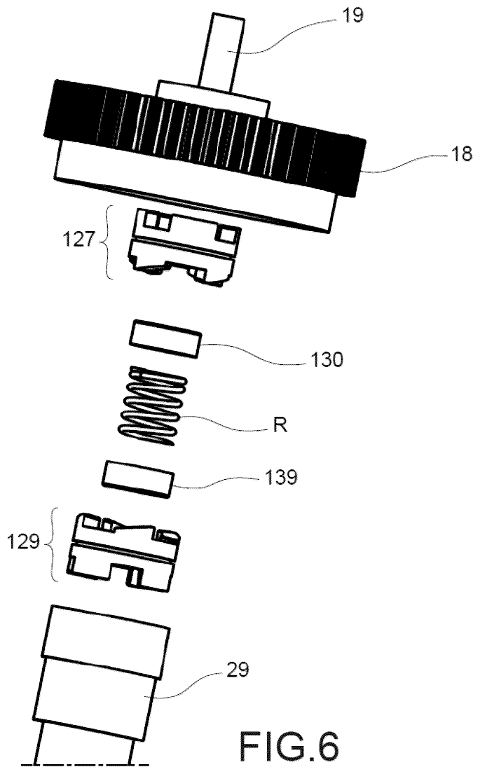

FIGS. 7A-7B show a variant of the drive means, including an engagement and disengagement mechanism, of a rotary distributor D (or, as explained above, of another rotary member), for example of the type described above in connection with FIGS. 3A-3C; in these FIGS. 7A-7B, reference numerals identical to those in the preceding figures, and in particular in FIGS. 4 and 5A-6, denote the same elements.

According to this variant, the translational guidance, along the shaft 19, is ensured centrally by a shaft 29′ which extends the shaft 29 (and is integral with it) and which penetrates the wheel 18 and the shaft 19. Alternatively, it may be provided by a skirt and a centering support, such as the elements 118 and 37 already described above (in connection, for example, with FIGS. 5A-5D).

The mechanisms set out above, in connection with FIGS. 4-7B, although satisfactory in some respects, nevertheless pose a problem in terms of compactness: indeed, the actuator S, 16 is located in the extension of the wheel 18 and its shaft 19, thus increasing the overall height of the assembly or the module. Often, however, an application of this type of device involves the drive train of a vehicle.

To solve this problem, according to another embodiment, the footprint is reduced by positioning the actuator along to a different axis, for example parallel to the shaft 19. Thus, the linear movement of the actuator is exerted parallel to the translational movement of the shaft 19 and the transmission means make it possible to transfer this linear movement from the actuator to the shaft 19 and therefore to the drive element that constitutes the gearwheel 18.

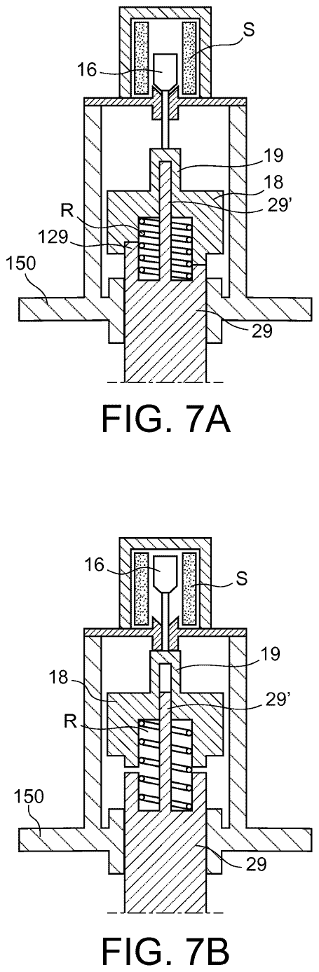

An example of this embodiment is illustrated in FIGS. 8A-8B , in which reference numerals identical to those in the preceding figures, and in particular FIGS. 4 and 5A-7B, designate the same elements, the invention being able to implement at least some aspects described above in connection with these FIGS. 4 and 5A-7B.

The actuator, for example in this case again a solenoid S and its plunger 16, is arranged along an axis BB′ parallel to the axis AA′ along which the shaft 19 and the gearwheel 18 can move in translation to engage with the shaft 29. The distance between the axis AA′ and the axis BB′ is not zero, for example is between 30 mm and 70 mm, for example it is about 50 mm.

The means 141, 142, 143 are used to couple the outlet 16′ of the plunger 16 and an end, herein referred to as the upper end, of the shaft 19. In this example, it is a pivot link 141 around a pivot point 142, which may be located along a shaft 143 positioned, for example, on the wall 152 of the actuator. Preferably, this shaft is arranged between, on the one hand, the assembly consisting of the wheel 18, its axis of rotation 19 and the shaft 29 and, on the other hand, the actuator S, 16. Thus, the vertical footprint of the entire device is greatly reduced. For example, the pivot link 141 is in the shape of an inverted “V”, the ends of the 2 arms of the V being connected, one to the end of the actuator and the other to the end of the shaft of the axis of rotation 19, while the tip of the V forms the pivot point 142 (which is therefore located at the top). In variants (not shown), a straight lever shape or a straight “V” shape is possible, but both take up more space than the inverted “V”.

According to one example, the distance between the pivot point 142 and the axis BB′ is, for example, between 10 mm and 50 mm, for example it is about 30 mm. This distance is less than that between the axes AA′ and BB′.

FIG. 8A shows the wheel 18 engaged with the shaft 29, the solenoid being energized and the plunger 16 activated in the high position; this wheel 18 can then be driven by means, for example a gear, for example as described above according to one of FIG. 1 or 2, including, for example, the wheel 20 shown in FIG. 4. In this position, the wheel 18 pushes the spring R (each end of which is located in a housing, respectively of the wheel 18 and of the shaft 29) and drives the shaft 29, and therefore the distributor (as in FIGS. 5A-7B, the latter is not shown), in rotation. FIG. 8B shows the wheel 18 disengaged from the shaft 29, the solenoid no longer being energized, the plunger 16 being in a low position with respect to its high position shown in FIG. 8A, and the upper end of the shaft 19 being in a high position with respect to its low position shown in FIG. 8A.

In other words:
when the actuator is activated, the return means R are in compression and the wheel (or the drive element) 18 is engaged with the shaft 29;
when the actuator is deactivated, the return means R are at rest, or less compressed than when the actuator is activated, and the wheel 18 (or the drive element) is disengaged from the shaft 29.

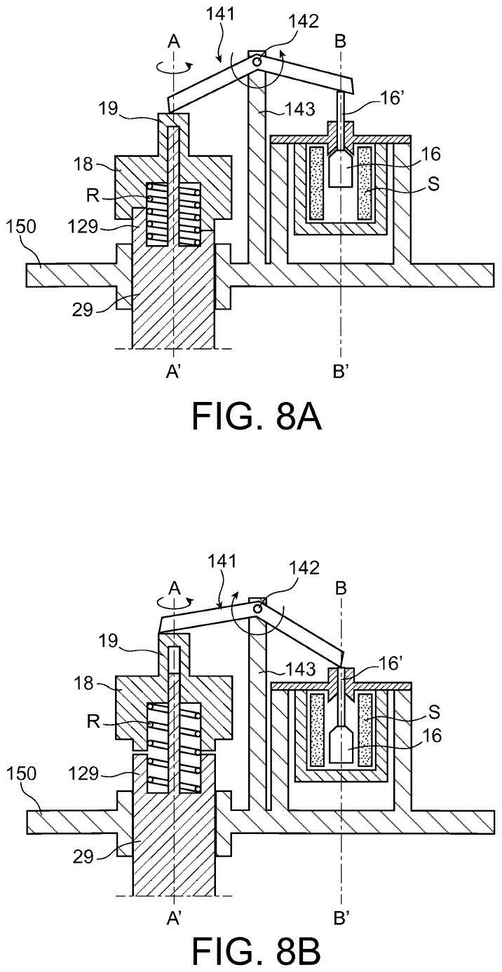

The arms of the link 141, on either side of the pivot 142, may be of identical or different lengths d₁, d₂ (see FIG. 9). In one preferred embodiment d₁<d₂, which makes it possible, for the same translation stroke of the actuator, to achieve a greater amplitude of translation of all the means 18, 19. Thus, for a same stroke of all the means 18, 19, the size of the solenoid can be reduced and the amount of copper and metal in it can also be reduced; this results in an economic saving as well as a reduction in weight of the whole module.

It is understood, using this example, that the activation means, or actuator, are moved to an unoccupied area, next to the coupling, which reduces the overall height of the system or module. The actuator is therefore in the inverted position with respect to the position it occupies in FIGS. 4-7B. As already mentioned above, the actuator shown here is electromagnetic, but it could also be pneumatic or hydraulic to provide reciprocating linear movement, either along the shaft 19 (embodiment in FIGS. 4-7B) or along the axis BB′ (embodiment in FIGS. 8A-9). In the latter case, when the actuator is actuated, the return means R are in compression and the wheel 18 is then engaged with the rotary shaft 29; when it is deactivated, the return means R resume their rest position and push back the wheel 18 which is then disengaged with respect to the rotary shaft 29.

FIGS. 8A-9 show a drive mechanism of a rotary distributor D. But this drive mechanism can be applied to drive another rotary member, provided with a shaft 29, for example another gearwheel, for example in a gear stage such as one of those described above in connection with FIG. 1 or 2. This drive mechanism can therefore be used to drive a gear stage, itself driving, for example, another gear stage or one or more distributors.

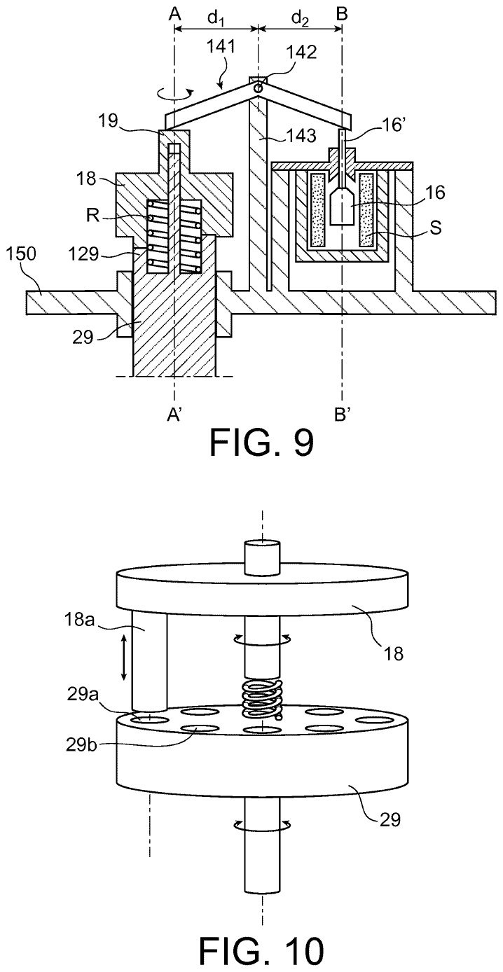

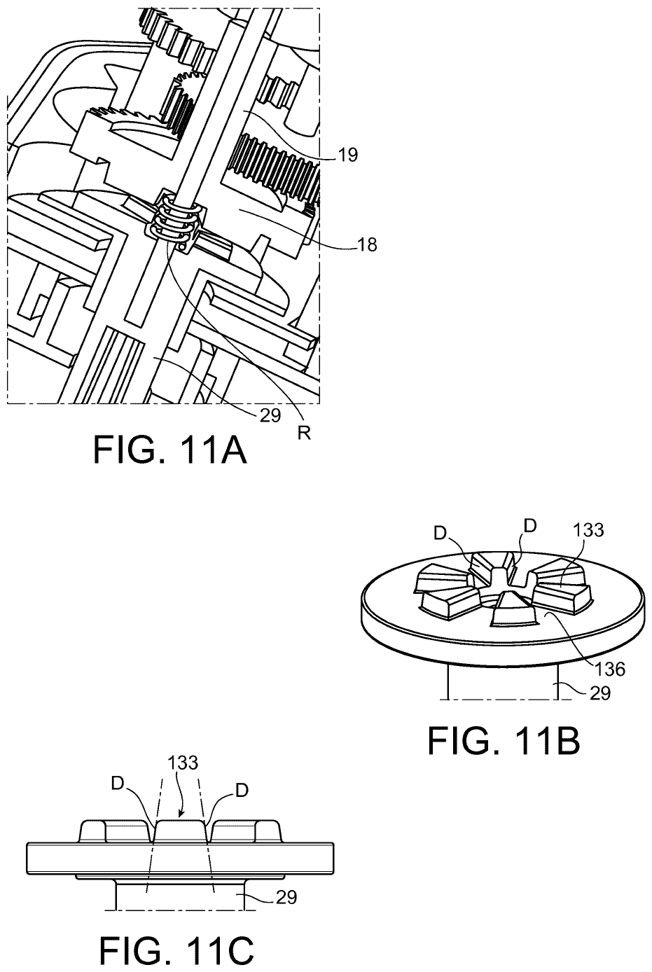

The wheel 18 and shaft 29 can be engaged by a coupling system using teeth and grooves, or a dog clutch, as shown above in connection with FIGS. 5C and 5D. Alternatively, it may be an engagement by key(s) 18a, as shown schematically in FIG. 10. The upper surface of the shaft 29 includes one or more ports for inserting a key 18a and thus rotating this shaft 29. FIGS. 11A-11C schematically show a variant of the drive means, including an engagement and disengagement mechanism, of a rotary distributor D, for example of the type described above in connection with FIGS. 3A-3C, and which can be applied to a device according to the invention for example as described in connection with FIGS. 8A-8C; in these FIGS. 11A-11C, reference numeral identical to those of the previous figures, and in particular in FIG. 4, or FIGS. 7A-9, denote the same elements.

As shown in FIG. 11A, the dog clutch 129 can be integrated into the shaft 29, just as the dog clutch 127 can be integrated into the wheel 18. Flanges such as 130 and 139 may, or may not, be used to limit the torsion of the spring R.

In this embodiment, the top or upper part of each tooth 133 is flat (FIGS. 11B and 11C), these upper parts being able to be in the same plane, whereas, in FIG. 5D, each tooth has a taper. The groove 136 is unchanged compared to the embodiment shown in FIG. 5D. The lateral faces of each tooth, denoted D, preferably have a taper (FIGS. 11B and 11C) to facilitate decoupling. This exemplary dog clutch enables engagement regardless of the direction of rotation of the wheel 18.

The drive means shown in FIGS. 11A-11C may be applied to a device according to the invention.

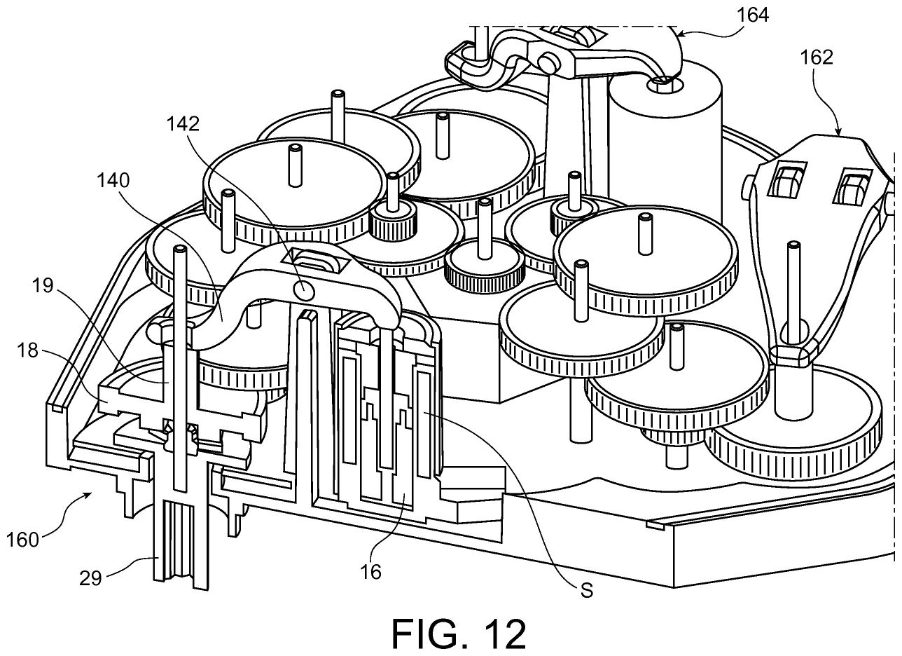

FIG. 12 shows a fluid distribution system including a plurality of devices according to FIGS. 8A-8C, these devices being identified by reference numerals 160, 162, 164, only the device 160 being shown in detail, in an exploded view.

An application of a device or system according to the invention relates to the distribution of a cooling water flow in a cooling circuit of a vehicle. But other applications may be concerned, for example the distribution of oil or gas (for example air or hydrogen) in a vehicle (car or truck, with combustion, electric or hybrid engine; or boat or flying machine), or the distribution of a fluid in a domestic application, for example a heat pump.

In a hydraulic system or circuit for distributing fluid(s) as described above and/or in connection with FIG. 1 or 2, each gear train may comprise at least two gear stages:
a first gear stage E_{1.1}-E_{1.d}, each gear of which is driven by said motor 10;
a second gear stage E_{2.1}-E_{2.d}, each gear of which is driven by the first stage,
a gear being provided with means S₁-S_{d} to engage or disengage it.

In a hydraulic system or circuit for distributing fluid(s) as described above and/or in connection with at least one of the figures, comprising electronic means 12 for controlling the motor 10, these electronic means 12 may be able to:
receive an operating mode command 26;
determine a target position of each of the d rotary distributors;
control the motor 10 and the means for engaging or disengaging each rotary distributor as a function of the target position of each of the rotary distributors.

In a device or a hydraulic system or circuit for distributing fluid(s) as described above and/or in connection with at least one of the figures, the means for engaging or disengaging each rotary distributor, or each rotary member, may include an actuator, for example of the electromagnetic (S₁, . . . S_{d}) or pneumatic or hydraulic type.

The invention also applies to a method for controlling the distribution of a fluid in a hydraulic fluid distribution system or circuit as described above and/or in connection with at least one of the figures, for example in a vehicle, this method including:
selecting one or more rotary distributors (D₁-D_{d}) to be actuated;
actuating said distributor(s) (D₁-D_{d}) using the motor (10) and means for engaging said distributor(s).

Such a method may comprise selecting or determining a direction and/or an angle of rotation of one or more distributors to be actuated and actuating said rotary distributor(s) according to this direction and/or this angle of rotation.

In such a method:
the fluid is, for example, water or oil or glycol or a gas, for example air or hydrogen; and/or

the hydraulic circuit is a cooling circuit or an oil or hydrogen distribution circuit for a vehicle.

1-28. (canceled)

29. A rotary drive device for a distributor in a fluid circuit, said rotary drive device comprising:
an output shaft;
a drive element extended by a shaft about which the drive element rotates along an axis of rotation and aligned with the output shaft;
an actuator with a linear movement along an axis different from the axis of rotation;
a coupler between the actuator with the linear movement and the drive element to actuate an end of the shaft of the drive element toward the output shaft; and
a clutch to engage the axis of rotation and the output shaft.

30. The device of claim 29, wherein the actuator is in the linear movement along an axis parallel to the axis of rotation.

31. The device of claim 29, wherein the coupler comprises a lever pivoting about a pivot, the lever connecting the actuator and the drive element.

32. The device of claim 31, wherein the lever comprises arms of equal length on either side of the pivot or of different lengths one either side of the pivot.

33. The device of claim 29, wherein the clutch comprises a coupling device using teeth and grooves or a coupling device using keys.

34. The device of claim 29, further comprising a compression spring to maintain the clutch in the disengaged position, the actuator and the drive element compressing the compression spring to engage the axis of rotation and the output shaft.

35. The device of claim 34, wherein the compression spring being arranged at least partially in a compartment, one end of which is provided with a part of the clutch.

36. The device of claim 29, wherein the actuator with linear movement being either: an electromagnetic actuator comprising a coil and a plunger which interacts with a field generated by the coil when a current flows through the coil, pneumatic or hydraulic.

37. The device of claim 29, further comprising a guide to guide the drive element in translation along the axis of rotation.

38. The device of claim 37, wherein the drive element comprises a gearwheel, the guide comprising a centering support which guides an inner surface of a wall of the gearwheel, the centering support being provided with teeth.

39. The device of claim 29, wherein the output shaft is extended by a guide shaft to penetrate the drive element.

40. The device of claim 29, wherein the drive element comprises a gearwheel; and
further comprising a wheel to drive the gearwheel, forming therewith a vertical shaft gear.

41. A rotary distributor comprising a rotary distributor body comprising a number of inlets and outlets greater than or equal to 3; and the rotary drive device of claim 29.

42. The rotary distributor of claim 41, wherein the inlets and outlets direct a fluid in a flow direction that is perpendicular to the axis of rotation.

43. A control system to control distribution of one or more fluids in a fluid circuit, comprising:
a motor; and
a plurality of rotary distributors for said one or more fluids, at least one of said plurality of rotary distributors comprises the rotary drive device of claim 29.

44. The control system of claim 43, further comprising an electronic controller to perform at least one of the following:
control the motor as a function of a signal or signals from one or more position sensors;
receive an operating mode command; and
determine a target position of each rotary distributor and control at least one of the motor and a processor to engage or disengage said each rotary distributor as a function of the target position of said each rotary distributor.

45. The control system of claim 43, wherein the fluid circuit is a circuit to distribute said one or more fluids in a thermal management circuit, or a circuit to distribute oil, dielectric fluid or hydrogen in a vehicle.

46. A vehicle comprising a motor, either thermal or electric, at least one fluid circuit and at least one system to distribute at least one fluid in said at least one fluid circuit, said at least one system comprising at least one pump and the control system of claim 43.

47. A rotary device for a fluid distributor in a fluid circuit, the rotary device comprising:
an output shaft;
a drive element extended by a shaft about which the drive element rotates along an axis of rotation and aligned with the output shaft;
an actuator with a linear movement along an axis different from the axis of rotation;
a lever pivoting about a pivot, the lever connecting the actuator with the linear movement and the drive element to actuate an end of the shaft of the drive element toward the output shaft; and
a coupling device using teeth and grooves or keys to engage the axis of rotation and the output shaft.

48. A method for controlling distribution of a fluid in a fluid circuit using the control system of claim 43, comprising:
selecting one or more rotary distributors to be actuated; and
actuating said one or more rotary distributors using the motor and a processor to engage said one or more rotary distributors.
